(19) United States
(12) Patent Application Publication
(10) Pub. No.: US 2021/0262059 A1
(43) Pub. Date: Aug. 26, 2021

(54) OPTIMIZED BIOPROCESSING METHOD

(71) Applicant: Darren Craig Megaw, Randparkridge (ZA)

(72) Inventors: Darren Craig Megaw, Randparkridge (ZA); Frank Kenneth Crundwell, Parkview (ZA)

(21) Appl. No.: 17/255,035

(22) PCT Filed: Jun. 28, 2019
(86) PCT No.: PCT/IB2019/055495

§ 371 Date: Dec. 22, 2020

(30) Foreign Application Priority Data
Jun. 28, 2018 (AP) AP/P/2018/010837

(51) Int. Cl. C22B 15/00; C22B 3/18; C22B 3/04

(52) U.S. Cl. CPC C22B 15/0071; C22B 3/04; C22B 3/18; C22B 15/0008

(57) ABSTRACT

Disclosed is method of leaching at least one desired element from feed material containing feed material fines, which includes combining such a feed material with a pulping solution comprising a liquid and a solution-hydrated or a solution-soluble polymer to form a treated slurry, with the polymer configured to predominantly capture at least part of the feed material fines prior to their settling out of the liquid slurry matrix, and with the polymer being added to the feed material in a predetermined ratio of polymer to feed material. The treated slurry is deposited in a deposition cell for leaching and further treatment. Also disclosed is a composition of a treated slurry, and treating any one or more of the feed material, the treated slurry or the deposited treated slurry with sulphide consuming bacteria.

### FIELD OF THE INVENTION

This invention relates to deposition leaching, of ore in heaps, cells or dumps (together, one or more or deposition cells) to obtain desired elements therefrom.

### BACKGROUND TO THE INVENTION

Deposition or heap leaching of ores as commonly practised, presents several practical limitations. Conventional heap leaching relies on the efficient transport of lixiviant from a point of entry into a heap to penetrate through an acceptable percentage of the heap. Permeability of the heap is a significant factor in the efficacy of a deposition leaching operation.

Care is normally taken when heaps are created from dry material, with heaps typically stacked on a bed to promote efficient flow of lixiviant through the heap. This can, to some extent, be managed in heaps that are dry-stacked by carefully grading and stacking the ore to achieve sufficient permeability in the heap. The most common practice is to screen out ultra-fine feed material and to deposit or stack the screen oversize material onto the heap. In some instances, a portion of the fines is re-introduced to the stacked oversize by agglomerating the fines to the larger oversize particles, prior to dry deposition stacking.

In deposition leaching operations of slurries, this is not conventionally possible, since a slurry usually, and per definition, contains a broad range of particle sizes, predominantly in a size fraction distribution range smaller than those contained for conventional heap leaching. Particles with smaller sizes tend to settle in a tightly packed mass when the water, carrier fluid or solution from a slurry drains from it. This densely packed mass is difficult to dewater and difficult to penetrate effectively with a lixiviant.

The presence of fines materials in any heap or deposition leaching operation is problematic since fines typically occupy and block spaces between larger particles, which inhibits the flow of lixiviant through the material in the heaps. In heaps where leaching is accompanied by forced aeration through the heap, the presence of fines is also problematic since it blocks pathways for air to travel through a heap.

Consequently, there is a need for an improved method of leaching feed ore material which contains such fines material.

In addition to the above, the prevention and remediation of pollution caused by the mining industry and in general is an ever-present concern. An example of a problem with mining operations is acid mine drainage, the treatment of which is difficult and costly. The restoration of contaminated water for re-use as process water or to potable quality relies on various processes including established technologies such as ion exchange and reverse-osmosis, while others are being developed or demonstrated.

Alkali metal ions (typically Na⁺ and K⁺ in the case of mining-related waters) are relatively difficult and expensive to remove from solution since they remain in solution during the low-cost bulk removal step of lime neutralisation that precedes many of the more sophisticated conventional treatment process. Notably, sulfates of the alkali metals remain highly soluble in solutions varying from highly alkaline to highly acidic.

There is therefore a need for a process whereby sulphates (and other similarly soluble ions) could be removed from solution, despite the high solubility of those metals in water.

The above-mentioned problems that require an improved method of leaching feed ore material and an improved method for treating contaminated water often exist and derive from the same operation. It is desirable to provide a solution which at least partly addresses both of these problems.

In this specification the term “dewater” means:
(i) the natural separation and expulsion of any carrier liquid composition associated with the slurry, during or after deposition of the slurry; the term is applied to any specific composition of slurry carrier and deposition liquid or solution composition and is not constrained to water in its pure form; and
(ii) the subsequent irrigation, draining and flushing of the deposited solids at the various process phases.

In the phrase “feed material fines” means particles that are generally too small for inclusion in conventional leaching operations, especially heap leaching operations, without agglomeration of some sort, since these particles would clog such heaps and impede efficient leaching, and the phrase “feed ore fines” means feed material fines from an ore origin.

### Objective of the Invention

It is an objective of the invention to provide a bioprocessing method for leaching material that contains feed ore fines and for biologically treating other materials, including water, which at least partly overcomes the abovementioned problems.

### SUMMARY OF THE INVENTION

In accordance with this invention, there is provided a method of leaching at least one desired element from feed material containing feed material fines, which includes—
combining a feed material that contains feed material fines with a pulping solution comprising a liquid and a solution-hydrated or a solution-soluble polymer to form a treated slurry, with the polymer configured to predominantly capture at least part of the feed material fines prior to their settling out of the liquid slurry matrix, and with the polymer being added to the feed material in a predetermined ratio of polymer to feed material;
depositing the treated slurry into a deposition cell to less than a predetermined maximum deposition height;
allowing the majority of the liquid in the treated slurry to naturally dewater from the fines solids in the cell;
applying a suitable lixiviant to the cell for a predetermined feed-solids-specific optimised time, with the lixiviant configured to leach the desired element from the cell;
allowing the lixiviant to drain from the cell as a pregnant leach solution;
flushing the cell with a suitable wash solution to displace entrained dissolved desired elements from the cell;
allowing the wash solution to drain from the cell; and
recovering pregnant leach solution and wash solution from the cell for downstream or upstream processing to recover the dissolved desired element from it.

According to a further aspect of the invention, there is provided for the polymer to be added to the feed material at one or more points within the process, and for the predetermined ratio of the polymer that is added to the feed material to be determined empirically by determining a ratio of polymer to feed material which provides the feed material with a deposition solids matrix percolation rate that is substantially similar, and preferably greater than, a target percolation rate, with the target percolation rate being the fluid percolation rate for such feed material in the absence of the feed material fines where the material naturally occurs or in its natural condition, and further preferably for the target percolation rate for African feed material, preferably African ores, to be approximately 10 L/m²/h.

There is still further provided for the maximum deposition height of the cell to be determined empirically by determining a height to which the treated slurry can be deposited without substantially limiting the percolation rate of the feed material of which it is comprised relative to its target percolation rate.

There is also provided for the feed-solids-specific optimised time to be determined empirically to represent a period within which a desired recovery of the desired element is possible from the treated slurry using the leaching process with a suitable lixiviant.

There is further provided for the feed material to be an ore, and further for the method to include sequential deposition of fresh ore on previously depleted ore to limit the footprint area of the deposition cell.

There is further provided for a recovered leach solution to be collected from the processing of the pregnant leach solution, and:
for the recovered leach solution to be applied to the deposition cell again; or
for the composition of the recovered leach solution to be adjusted and reapplied to the deposition cell again; or
for the recovered leach solution to be applied to a different deposition cell; or
for the composition of the recovered leach solution to be adjusted and applied to a different deposition cell, optionally with the addition of fresh lixiviant or other additives to the extent required by the presence of at least one desired element in the cell.

There is further provided for the polymer to be chosen to complement the type and nature of the desired element and of the feed material fines which contain the desired element, and the conditions in which it will be used.

There is further provided for a slurry composition configured for the recovery of at least one desired element from the slurry through deposition leaching, the slurry comprising a feed material that contains feed material fines, a suitable repulping solution, and a solution-hydrated or solution soluble polymer, with the polymer configured to predominantly capture at least part of the feed material fines prior to their settling out of the liquid slurry matrix, and with the polymer being added to the feed material in a predetermined ratio of polymer to feed material determined empirically by determining a ratio of polymer to feed material which provides the feed material with a deposition solids matrix percolation rate that is substantially similar, and preferably greater than, a fluid percolation rate for such feed material in the absence of the feed material fines in the feed material's natural location or natural condition.

According to a further aspect of the invention there is provided for the method to include the step of treating any one or more of the feed material, the treated slurry and the deposited treated slurry with sulphide consuming bacteria.

These and other features of the invention are described in more detail below.

### BRIEF DESCRIPTION OF THE DRAWINGS

A preferred embodiment of the invention is described by way of example only and with reference to the accompanying drawing in which:

FIG. 1 is a flow diagram showing a process flow of the method of the invention;

FIG. 2 is a graphical representation of a comparison of deposition percolation rates of solids treated according to the process of the invention vs an industry base-line;

FIG. 3 is a graphical representation of the improvement in percolation (irrigation) rates for the same material, when treated according to the process of the invention vs untreated;

FIG. 4 is a graphical representation of the acid-soluble copper recovery rates achieved in the laboratory column tests of the process of the invention;

FIG. 5 is a simplified process block flow diagram of the Demonstration Plant;

FIG. 6 is a photograph of the Demonstration Plant;

FIG. 7 is a photograph of cells in the Demonstration Plant under irrigation;

FIG. 8 is a graphical representation of the acid-soluble copper recovery from the Demonstration Plant cells vs a conventional heap leach process;

FIG. 9 is a graphical representation of the cumulative average acid consumption of the process of the invention vs a conventional heap leach process; and

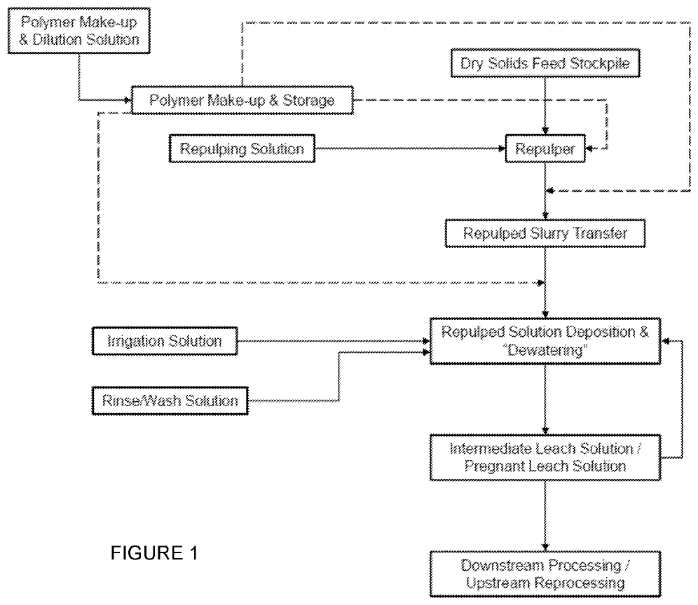

Table 1 shows the Demonstration Plant total copper and acid-soluble copper recoveries (Head and residue solids assays);

### DETAILED DESCRIPTION OF THE INVENTION

In heap leaching operations, fines inventory build-up is usually as a result of excessive fines generation during heap leach size reduction and classification unit operations. Most heap leach operations re-introduce the fines into the heap feed, by way of agglomeration, prior to heap deposition. Maximum blend ratios of fines to competent heap leach solids of 15 to 20 mass % for many heap leach operations, are typical. Many oxide ores, however, are often characterized by higher ratios than these maximum heap leach processing course-fine-agglomeration-blend ratios, in fines generation, which results in Run-of-Mine (“ROM”) fines stockpile inventories being generated. In scenarios such as this, unless the copper processing flowsheet has a secondary processing route to treat the fines, the options for beneficiation of such stockpiles is limited. In tank leach operations, the stockpiles are mostly associated with ore that is classified as mineralized waste or pit development strip overburden, with copper content below the Life-of-Mine (“LOM”) cut-off grade and for which the processing economics are not favorable.

A preferred embodiment of the invention is intended for use in the treatment of desired element-containing ores, via slurry deposition and lixiviant irrigation. It provides a deposition leaching process route for the treatment of fine and ultra-fine materials in a homogenous particle size distribution deposition matrix, that amplifies deposited solids percolation rates, to a level similar to, and, in most applications, superior to those achieved by conventional heap leaching of the same feed ore types. The combination of repulping feed solids with an appropriate lixiviant solution prior to deposition into the FOHL leaching cells, plus the amplified surface exposure of the fines and ultra-fines to the appropriate lixiviant, during deposited solids matrix irrigation, results in vastly improved leach kinetics, when compared with conventional heap leaching of the same material.

A feed material, in the form of an ore, which contains ore fines and which may be in dry, semi-dry or wet condition, is converted into a slurry by pulping it (or repulping it if it had been in a pulp condition before).

The feed material is pulped by combining a pulping solution with it to form a treated slurry. The pulping solution contains a fluid (solution) and a solution-soluble polymer. The polymer is configured to dewater the slurry. The specific polymer will depend on the type and nature of the desired elements, and of the ore fines which contain it. The polymer will be selected to complement that, and the specific conditions in which it will be used.

The polymer is added to the feed ore fines material in a predetermined ratio and at one or a number of points within the process. The polymer gives significant structural stability to deposited, dewatered solids, and this structural stability is maintained through the subsequent leach irrigation cycles.

The treated slurry is deposited into a cell on a deposition site to less than a predetermined maximum deposition height or depth. The cell is allowed to dewater under force of gravity, with the polymer binding the feed ore fines loosely into larger solids matrices and reducing size and density segregation of coarse and fine particles. This reduces the tendency of the fines particles to clog the void spaces in the deposition cell which allows more pathways for fluid through the deposited solids layers, including solution, lixiviant and air.

The deposited solids mass in the cell thus dewaters under force of gravity, which leaves a solids bulk deposition with a density that is less than would have been attainable had the same feed material solids been deposited without addition of the polymer.

The polymer is a commercially available polymer for enhanced tailings disposal, which is conventionally used to dewater tailings from various processes.

After dewatering, the deposition cell is treated with forced irrigation by applying a suitable lixiviant to its upper surface. This may be done by means of sprinklers or wobblers, drip irrigation systems, or other conventional irrigation systems or methods, placed on or near the deposition solids surface and through which the lixiviant is pumped.

The lixiviant can be fresh or from a recycled leach solution with a replenishment of fresh lixiviant. After an optimal irrigation time, the deposition cell is allowed to drain again under force of gravity.

The heap is then flushed with a suitable wash solution to displace entrained dissolved desired elements from the deposition cell. The wash solution which contains such elements is collected from the base of the deposition cell, either via natural seepage and/or by means of designed drainage piping systems.

To some extent, the recovered solutions all comprise pregnant leach solutions. Each solution may also contain different elements, since these may be released from the heap at different leaching preferences and rates. All of these pregnant leach solutions may be processed further to recover or purify desired elements.

As mentioned above, the polymer is added to the feed material in a predetermined ratio of polymer to the feed material at one or more points along the processing circuit. This ratio is determined empirically by determining a ratio of polymer to feed material that provides this feed material with a deposition solids matrix percolation rate that is substantially similar, and preferably greater to a target percolation rate. The target percolation rate is the fluid percolation rate for the specific material in the absence of the feed ore fines and in its natural location or condition. By way of example the target percolation rate for African ores is approximately 10 L/m²/h. This depends on local geography and rainfall and may be different in other locations around the world.

The maximum deposition height/depth of the cell is also determined empirically by determining a height to which the treated slurry can be deposited without substantially limiting its percolation rate relative to its target percolation rate.

The principle behind this is that by injecting the polymer into the feed material, the resulting cell deposition formed by the presence of the polymer becomes in effect more porous. If the treated slurry is deposited too high, the weight of the material will cause it to close up again by crushing the voids, which increases its density and decreases the maximum percolation rate possible through it. Hence, empirical tests are conducted to determine to which height the specific feed material, in its form as a treated slurry, can be deposited without limiting its actual attainable percolation rate to significantly below its target percolation rate.

In a specific application, a mineral processor or mine operator may still elect to deposit the deposition cell higher due to other considerations, but at least then with the empirical data in hand the negative impact of higher or deeper deposition is highlighted in terms of reduced percolation rates, longer processing times and lower recovery rates.

The optimum deposition height or depth is defined per deposition lift, with a “lift” being defined as the maximum deposition height or depth for a specific feed material, that upon deposition and draining, will be irrigated with a suitable lixiviant for a predetermined optimum period, drained and flushed for a predetermined optimum period, and drained. The number or sequence of irrigation, drainage, flushing and draining cycles are not predetermined or fixed and may vary for different feed material types and target recoverable material. Once a lift of feed material has been sufficiently depleted of target recoverable material (desired elements) content, sequential lifts may be deposited above the initial lift to a deposition height or depth specific to the feed material, and this deposition lift is subjected to the same or similar sequences of draining, irrigation, draining, flushing and draining cycles.

The recovered leach solution may be collected from the processing of the pregnant leach solution, which may be applied to the deposition cell again, optionally with the addition of fresh lixiviant or other processing additives to the extent required by the presence of desired elements in the cell. The wash solution may also be recovered for recycling, reirrigation or further processing. The wash solution composition may or may not include fresh lixiviant or other processing additives.

A further aspect of the invention relates to the slurry itself. The slurry composition is configured for the recovery of desired elements from the feed material, in the form of a treated slurry, through deposition leaching. The treated slurry includes the material that contains feed ore fines, a suitable repulping solution and the solution-soluble polymer configured to dewater the slurry. The polymer can also be a solution-hydrated polymer. As described above, the polymer is added to the feed material at one or various points within the process in a predetermined ratio determined empirically by determining a ratio of polymer to feed material which provides the feed material with a deposition solids matrix fluid percolation rate that is substantially similar, and preferably greater, than a fluid percolation rate for such feed material in the absence of the feed material fines in the feed material's natural location or natural condition.

Test Work

The process according to the invention has been developed largely around the testing of African Copperbelt oxide feed material. To date, different ores from seven different copper oxide processing sites have been tested successfully. The following section summarizes the findings of the laboratory and field tests conducted for selected feed ore stockpiles tested from one of the seven processing sites. The reason for selecting to present the results from this specific site, in favor of tests conducted for the other sites, is that the same site was used to run the subsequent demonstration plant trial.

1. Laboratory Column Tests

Once the optimum polymer dose rate was determined for the selected target feed material, a known mass of the solids material was repulped with dilute sulfuric acid solution of predetermined concentration. The strength of the dilute sulfuric acid solution used for solids repulping and for subsequent irrigation of the deposited solids, was chosen based on one or more of the following factors:
Target acid-soluble copper content in feed solids (stoichiometric acid requirement).
Gangue-acid consuming mineral content in feed solids.
Composition of existing client process acid streams used for leaching (e.g. copper SX raffinate compositions).
Repulped slurry equilibrium pH.

The repulp liquid: solid ratio for all the tests was standardized. The polymer mass was varied for each test, based on the predetermined optimum polymer dose rate for each feed material. The polymer-conditioned slurry from each test, was deposited into individual laboratory-scale leach columns, where the repulp solution from deposition was drained, through the settled solids column and captured in column off-flow intermediate leach solution (ILS) containers, positioned underneath each column. The mass of solids for each test was determined, in order to achieve 3 meters of free-settled solids height in the associated test column. For each test feed material, the column leach was irrigated with the ILS solution over a period of time, at an irrigation rate that was sustainable. Sustained irrigation rate for the process of the invention is defined as the maximum permissible solution flow, onto the deposition solids surface area, that can be sustained, without visible pooling of solution developing on the surface.

Recycled ILS solution free-acid concentrations were controlled by daily pH measurement and adjustment with manual addition of measured quantities of 98% concentrated sulfuric acid dosed into the ILS containers. Free-acid content of the ILS was controlled, in order to produce column off-flow solutions that would be similar in composition to typical pregnant leach solution (PLS), that could be fed to copper SX circuits. Daily product solution samples were taken and submitted for elemental analysis, to monitor leach kinetics.

2. Laboratory Test Results

a. Polymer Treated Solids Deposition Permeability and Percolation Rate

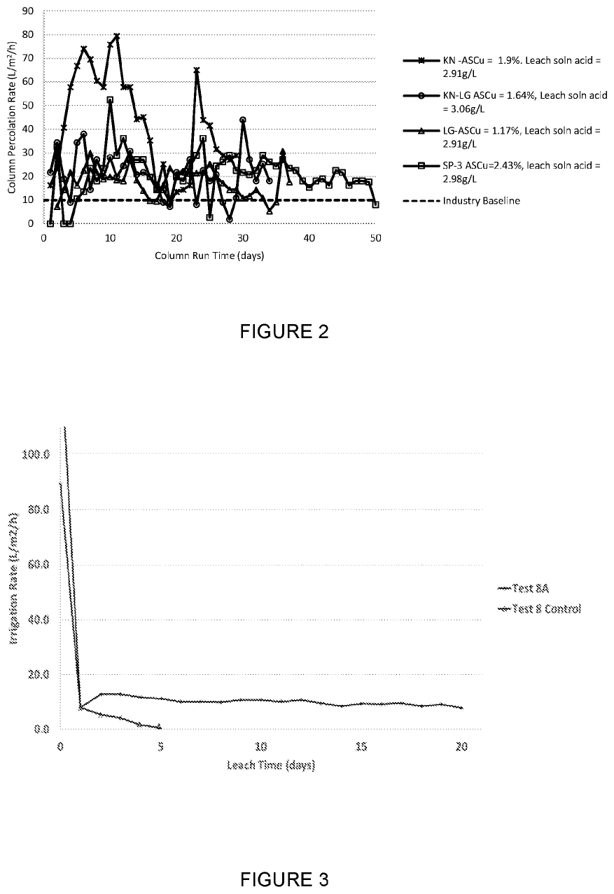

FIG. 2 shows the average percolation rates achieved for selected treated solids, from various copper oxide feed ores. The leach times for the column tests illustrated, were determined by the extent of recovery of acid-soluble copper. Daily measured percolation rates are expressed in litres per square meter per hour (L/m²/h), based on the surface area of the test columns and the achieved sustained irrigation rate. The percolation rates are compared to an industry baseline of 10 L/m²/h, which is considered an acceptable sustained irrigation rate for copper heap leach operations.

The percolation (irrigation) rates for all tests, were consistently high and above the industry baseline comparison and these elevated percolation rates were sustained throughout the applied column leach cycles. In FIG. 2, the few points that do fall below the 10L/m²/h industry baseline, were due to phases of column drainage, i.e. within the first 5 days of each column test commencing, or as a result of periods of irrigation pump power failures. Even for the least-responsive solid material tested, there was a significant improvement in percolation rate of treated solids, when compared with a column test attempted with untreated solids. The improvement in percolation rate is shown in FIG. 3 for a less responsive feed solid.

The treated solids showed a minimum of 50% improvement in percolation characteristics of the deposited solids.

b. Acid-Soluble Copper Recoveries

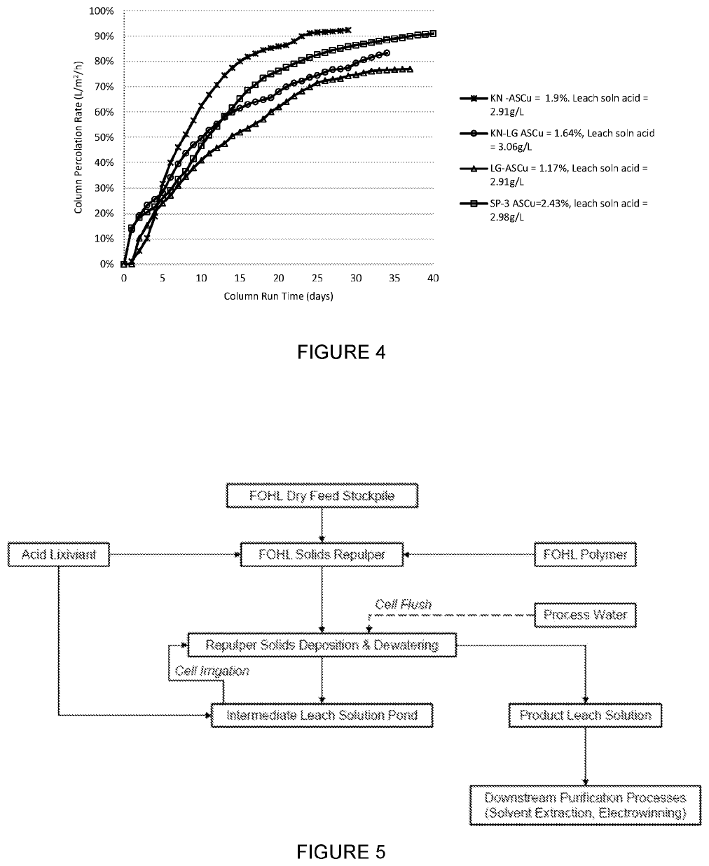

FIG. 4 shows the acid-soluble copper recoveries over time for the treated solids deposition column tests. The feed solids acid-soluble content and the associated feed acid concentration in the repulp and leach solution for each test are denoted in the graph legend.

For all materials tested via the process of the invention and that showed favorable sustained percolation rates, the leach kinetics gave acceptable acid-soluble copper recoveries within 30 to 35 days of column deposition.

3. Experimental-Demonstration Plant

Upon the completion of extensive laboratory test campaigns on various copper oxide feed ores, a 6-month demonstration plant trial was conducted at an existing African Copperbelt heap leach operations site. The ore treated in the demonstration plant was from the same source as the ore tested in the laboratory-scale column tests.

a. Demonstration Plant Process Flow Description

FIG. 5 is a simplified block flow diagram of the process circuit operated for the demonstration test.

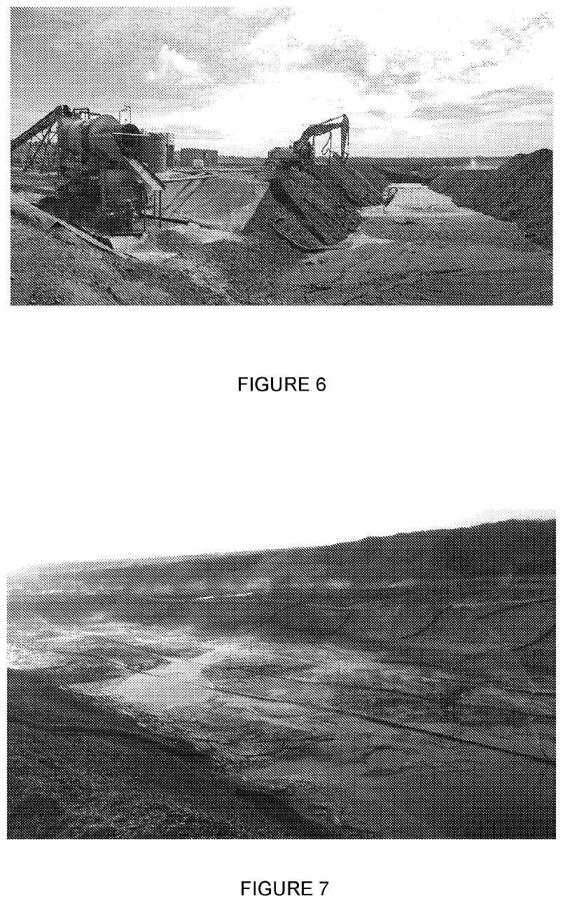

Feed solids from existing copper oxide fines stockpiles, were treated via the process flow sheet and discharged into an existing valley, between two existing operational heap leach pads. The valley was divided into 6 leach cells, with roughly equivalent solids deposition volume capacities. The width of the valley in which the cell solids deposition took place, varied according to the adjacent existing heaps natural slope angles. FIG. 6 shows the demonstration plant site and the circuit in operation.

Feed solids were conveyor-fed into the repulper at a set feed rate. The feed solids were periodically sampled by means of manual belt cuts from the feed conveyor, with daily composite feed samples submitted for total copper and acid-soluble copper content analysis. The demonstration plant deposition cycle was run for a total of four months, with an average dry solids feed rate of 15 tons per hour achieved. The feed solids were repulped at a fixed ratio, with dilute acid process solutions (solvent extraction raffinate) and conditioned with a fixed dose rate of polymer. The conditioned slurry was pumped and systematically deposited, sequentially, into the prepared deposition cells. Each cell was equipped with a deposition drainage underflow piping reticulation, to channel the product leach solutions from the deposition cells to the existing intermediate leach (ILS) and PLS ponds. A maximum deposition depth of 3 meters was used to signal the final lift solids height per cell, for each cell leach cycle. Repulped, conditioned solids were pumped into the individual cells until an average of 3 meters of solids depth was achieved across the surface of the cell. Once the target deposition depth had been reached, the solids deposition was advanced to the following prepared downstream cell. The completed deposition in the upstream cell was allowed to drain naturally of entrained repulp solution, before applying acid irrigation piping reticulation to the surface of the deposited solids. The cell was then irrigated with dilute acid leach solution. FIG. 7 shows one of the cells under acid irrigation.

Monitoring of the acid-soluble copper leach progress from each cell, was achieved throughout the leach cycle by sampling the off-flow product solutions, by way of the dedicated off-flow drainage transfer lines. Copper mass transfer from deposition solids to product leach solution was determined by in-line flow monitoring (irrigation leach solution) and delta-copper analysis between product off-flow solutions and on-flow irrigation solutions. Once a sufficient extent of acid-soluble copper had been leached from the irrigated cell, the acid irrigation was turned off and the entrained leach solution allowed to naturally drain from the copper-depleted leach solids. After cell drainage completion, the depleted copper cell was irrigated with process water to displace entrained soluble copper. The final barren solids depositions were core-sampled at defined grid intervals and the cores analyzed for residual acid-soluble copper content. The final cell mass balance closure was determined, based on the assessment of both the solution-copper and solids-copper mass balances, using the

Metal Management Solutions “Wire” metals accounting software. For two of the 6 cells tested, a second 3-meter lift of solids deposition was completed, to demonstrate sequential “stacking” of the deposition.

4. Demonstration Plant Results

a. Copper Deposition and Acid-Soluble Copper Recovery Rates

Table 1 lists the Demonstration Plant total copper and acid-soluble copper recoveries (based on head grade and residual solids analysis).

The key variance between the laboratory column test data and the demonstration plant data, was the total leach time for each FOHL cell deposition. The demonstration plant leach duration was approximately double that achieved for the laboratory column test. Contributing factors to this extended leach time were identified:
Periods of insufficient acid mass flow in irrigation solution—this was mainly due to repulp-phase and irrigation-phase acid solution pump downtime (process availability) and constraints on acid supply availability to the FOHL demonstration plant, in favor of the primary production heap leach operations acid demands. Interruptions and periods of non-optimum operation are a reality in production process operations, and as such, the FOHL demonstration plant is a more accurate reflection of the expected performance of the FOHL leach process.

b. Comparison of Process of the Invention and Conventional Heap Leaching Acid-Soluble Copper Recoveries

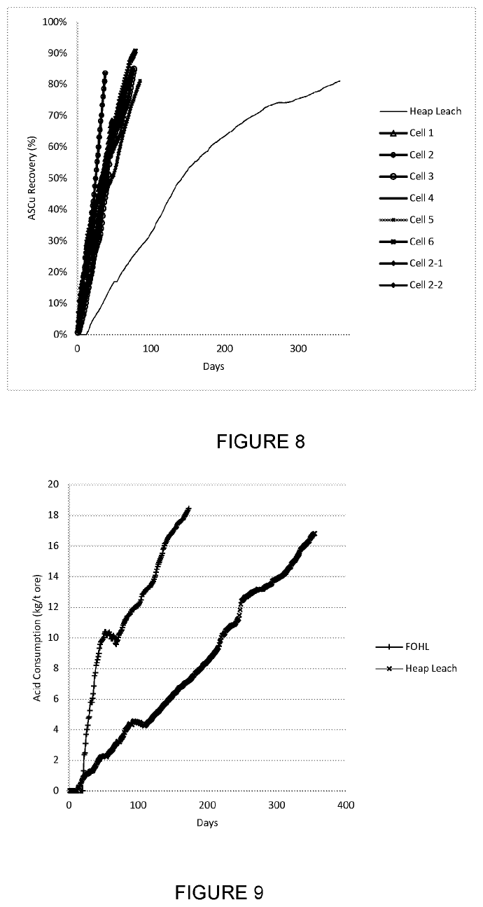

FIG. 8 compares the individual cell's acid-soluble copper leach kinetics with those of an existing heap leach for the same feed ore. The selected existing heap leach performance is considered to be typical for the ore treated.

The individual cells all achieved above, or close to 80% recovery of deposited acid-soluble copper within 70 to 85 days. The conventional heap leach achieved 81% recovery of acid-soluble copper after 356 days. On a full-scale plant, for the material tested, the rate of recovery to achieve >80% of acid-soluble copper recovery per ton of deposited feed solids is therefore 80 to 85 days.

c. Comparison of Conventional Heap Leach and the Process of the Invention's Acid Consumption Rates

Project budget constraints for the Demonstration Plant, mandated the decision to use the identified valley between the site's existing heap leaches for the Demonstration Plant. The motivation for the site selection made sense, as it was an existing well-established heap leach pad area, with the necessary environmental liners, solution ponds and pumping infrastructure, largely in place. In order to accommodate the project budget, the decision was taken not to plastic-line the existing adjacent heap leach pads side walls. This was easy to motivate without compromising the assessment of the project primary assessments of copper leach kinetics and recoveries, as this assessment was based on head and final barren solids copper analyses, with on and off-flow solution analyses being used to monitor daily trends only. The decision not to line the adjacent heap leach walls, did make the assessment of acid consumption for the trial more challenging, as there were definite solution cross flows from one of the conventional heap leaches to the cells and similar solution cross flow from the cells to the subsequent adjacent heap.

Applying material mass balances first principles to this scenario allowed for reconciliation of the PLS free acid. Equation 1 represents the mass balance formulation which contains two unknowns:
i) the crossflow volume from conventional heap leach to the process, and
e free acid concentration of the PLS stream. A realistic assumption of 20% crossflow of the HL PLS was applied to solve the unknown crossflow volume. Solving for the free acid concentration in the PLS based on these principles and assumption, back calculates the free acid of the PLS before the two streams combine and isolates the process from the rest of the heap leach process. The sensitivity of this methodology was tested by changing the assumed 20% crossflow to as much as 40%, which increased the acid consumption of the process by only 0.8%.

iii)

F_{c}C_{c}=(F_{HL}*C_{HL})+F_{FOHL}*C_{FOHL}) (1)

### Where:

F_{c}=Volumetric flow of combined HL PLS crossflow and PLS off-flow stream (F_{c}=F_{HL}+F_{FOHL})

C_{c}=Free acid concentration of combined HL PLS crossflow and off-flow stream, sampled and analysed by laboratory after mixing in process;

F_{HL}=volumetric flow of HL PLS crossflow, based on assumption;

C_{HL}=Free acid concentration of HL PLS crossflow, sampled and analysed by the laboratory from separate HL PLS off-flow;

F_{FOHL}=volumetric flow of PLS, based on flowmeters;

C_{FOHL}=Free acid concentration of off-flow, the unknown to be solved in Equation 1;

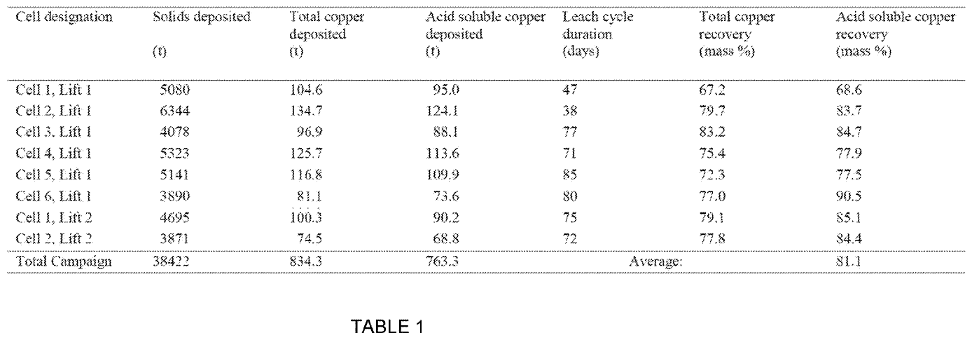

FIG. 9 compares the cumulative acid consumption rates for the process cells to the selected conventional heap leach.

The normalized acid consumption shows a slightly higher acid consumption of 18.42 kg/ton for the process leach in comparison to 16.8 kg/ton. This is mostly attributed to the slightly higher gangue acid consumption associated with increased solids surface area exposed to acid solution, as a result of the smaller particle size fractions in the overall particle size distribution of the feed material.

5. CONCLUSION

The processing of copper oxide fines material according to the invention showed favourable acid-soluble copper leach kinetics at laboratory and demonstration plant scales. The demonstration plant performance showed superior leach kinetics when compared to conventional heap leaching of the same ore type ,with replicable leach performances being achieved.

It will be appreciated that the above embodiment is given by way of example only and is not intended to limit the scope of the invention. It is possible to alter aspects of this embodiment without departing from the essence of the invention.

1-15. (canceled)

16. A method of leaching at least one desired element from feed material containing feed material fines, the method comprising:
combining a feed material that contains feed material fines with a pulping solution including a liquid and a solution-hydrated or a solution-soluble polymer to form a treated slurry, with the polymer configured to predominantly capture at least part of the feed material fines prior to the at least part of the feed material fines settling out of the liquid slurry matrix and with the polymer being added to the feed material in a predetermined ratio of polymer to feed material;
depositing the treated slurry into a deposition cell to less than a predetermined maximum deposition height;
allowing the majority of the liquid in the treated slurry to naturally dewater from the fines solids in the cell;
applying a suitable lixiviant to the cell for a predetermined feed-solids-specific optimized time, with the lixiviant configured to leach the desired element from the cell;
allowing the lixiviant to drain from the cell as a pregnant leach solution;
flushing the cell with a suitable wash solution to displace entrained dissolved desired elements from the heap;
allowing the wash solution to drain from the cell; and
recovering pregnant leach solution and wash solution from the cell for downstream or upstream processing to recover the dissolved desired element from it.

17. The method as claimed in claim 166 wherein the polymer is added to the feed material at one or more points within the process.

18. The method as claimed in claim 166 wherein the predetermined ratio of polymer that is added to the feed material is determined empirically by determining a ratio of polymer to feed material which provides the feed material with a deposition solids matrix percolation rate that is at least substantially similar to a target percolation rate, with the target percolation rate being the fluid percolation rate for such feed material in the absence of the feed material fines where the material naturally occurs or in its natural condition.

19. The method as claimed in claim 168 wherein the deposition solids matrix percolation rate is greater than the target percolation rate.

20. The method as claimed in claim 168 wherein the target percolation rate for African feed material is approximately 10 L/m²/h.

21. The method as claimed in claim 169 wherein the African feed material comprises African ores.

22. The method as claimed in claim 166 wherein the maximum deposition height of the cell is determined empirically by determining a height to which the treated slurry can be deposited without substantially limiting the percolation rate of the feed material of which it is comprised relative to its target percolation rate.

23. The method as claimed in claim 166 wherein the feed-solids-specific optimized time is determined empirically to represent a period within which a desired recovery of the desired element is possible from the treated slurry using the leaching process with a suitable lixiviant.

24. The method as claimed in claim 166 wherein the feed material includes an ore.

25. The method as claimed in claim 22, further comprising sequential deposition of fresh ore on previously depleted ore to limit the footprint area of the deposition cell.

26. The method as claimed in claim 166 in which a recovered leach solution is collected from the processing of the pregnant leach solution, and
a. the recovered leach solution is applied to the deposition cell again; or
b. the composition of the recovered leach solution is adjusted and reapplied to the deposition cell again; or
c. the recovered leach solution is applied to a different deposition cell; or
d. the composition of the recovered leach solution is adjusted and applied to a different deposition cell, optionally with the addition of fresh lixiviant or other additives to the extent required by the presence of at least one desired element in the cell.

27. The method as claimed in claim 166 wherein the polymer is chosen to complement the type and nature of the desired element and the conditions in which it will be used, and the nature of the feed material fines which contain the desired elements.

28. The method as claimed in claim 166, further comprising treating the feed material with sulphide consuming bacteria.

29. The method as claimed in claim 166, further comprising treating the treated slurry with sulphide consuming bacteria.

30. The method as claimed in claim 166, further comprising treating the deposited treated slurry with sulphide consuming bacteria.

31. The method as claimed in claim 166, further comprising treating any one or more of the feed material, the treated slurry and the deposited treated slurry with sulphide consuming bacteria.

32. A slurry composition configured for the recovery of at least one desired element from the slurry through deposition leaching, the slurry comprising:
a feed material that contains feed material fines;
a suitable repulping solution; and
a solution-hydrated or a solution-soluble polymer;
wherein the polymer is configured to predominantly capture at least part of the feed
material fines prior to the at least part of the feed material fines settling out of the liquid slurry matrix, and with the polymer being added to the feed material in a predetermined ratio of polymer to feed material determined empirically by determining a ratio of polymer to feed material which provides the feed material with a deposition solids matrix percolation rate that is at least substantially similar to a fluid percolation rate for such feed material in the absence of the feed material fines in the feed material's natural location or natural condition.

33. The slurry composition as claimed in claim 32 wherein the deposition solids matrix percolation rate that is greater than the fluid percolation rate for such feed material in the absence of the feed material fines in the feed material's natural location or natural condition.
